(19) United States
(12) Patent Application Publication
(10) Pub. No.: US 2003/0009365 A1
(43) Pub. Date: Jan. 9, 2003

(54) System and method of content management and distribution

(76) Inventors: Dermot Tynan, Aughinish (Near Kinvara) (IE); Oliver Leahy, Galway (IE); Sean Doherty, Galway (IE); Morgan Doyle, Galway (IE)

Correspondence Address: Carol H. Peters, Mintz, Levin, Cohn, Ferris,, Glovsky and Popeo, P.C., One Financial Center, Boston, MA, 02111, US

(21) Appl. No.: 09/853,504

(22) Filed: May 11, 2001

(30) Foreign Application Priority Data
Jan. 9, 2001 (IE) S2001/0015

(51) Int. Cl. G06F 17/60

(52) U.S. Cl. 705/9

(57) ABSTRACT

A method and a client/server system for managing content for distribution comprising is disclosed. The invention has particular (but not exclusive) application to managing content in the form of web pages for distribution by a web server. A delegator identifies content to be worked upon and delegates the work to a delegatee. A server sends to the delegates a manifest describing the delegated work, the manifest defining the extent of work to be done. The server receives content from the client together with the returned manifest, each manifest and the associated content being digitally identified by the delegatee. The returned content is accepted by the server only upon verification of the digital identification.

### CLAIM TO PRIOR APPLICATION

The present application claims foreign priority benefits under Title 35, U.S. Code §119(a)-(d) or §365 to Irish Patent Application No. S2001/0015, filed Jan. 9, 2001, which is incorporated herein by reference.

### FIELD OF THE INVENTION

This invention relates to a content management and distribution system. It has particular, but not exclusive, application to secure distribution of content from a content originator to a content server, such as a web server.

### BACKGROUND OF THE INVENTION

As web sites hosted on the Internet or on other networks become more complex, it is usual that content of a web site will be developed by more than one person, with a webmaster in overall charge of the content and structure of the site. The webmaster may typically delegate the task of originating content of the site to one or more delegatees, each of which has a specific area of responsibility. Tasks may then be further delegated by content originators within their field of responsibility. Very often, the delegatees will be in geographically diverse locations, and will communicate with the webmaster over a network link.

Webmasters are therefore presented with several problems in maintaining such a website. A webmaster must ensure that the content providers can work only within their delegated field of responsibility. They must ensure that only those people who are authorised can amend the content. In the event that the content providers are remote, they must ensure that content is genuine, and has originated from the delegate. When content is received from a content provider, they must ensure that it is properly stored on a server for subsequent access. This last task is normally achieved by replicating a directory on a computer system of the content provider to an appropriate part of the file system of a server computer.

### SUMMARY OF THE INVENTION

An aim of this invention is to facilitate the above-described tasks of a webmaster.

From a first aspect, the invention provides a method of managing content for distribution comprising: a delegator identifying content to be worked upon and delegating the work to a delegatee; sending to the delegatee a manifest describing the delegated work, the manifest defining the extent of work to be done; receiving content from the delegatee together with a returned manifest, each manifest and the associated content being digitally identified by the delegatee; the returned content being accepted only upon verification of the digital identification.

By means of this method, a server can ensure that received content genuinely originates from the person to whom it was delegated, that the content has not been changed, and that the delegatee can only store their content in an appropriate part of the content hierarchy.

Typically, in a method embodying the invention, prior to assigning content to a delegate, a public cryptographic key is obtained from the delegatee. This can be used in future to identify content from the delegatee.

The returned manifest may be identified by a digital signature of the delegatee. Typically, such a digital signature is verified by decryption using the delegatee's public key. Advantageously, the digital signature is a message digest encrypted with a public key which is stored in accordance with the X509 certificate structure. This is a recognised standard that provides a high level of security.

In addition to the manifest itself, each file that accompanies a manifest is digitally identified and is accepted only upon verification of the digital identification.

In a method embodying this invention, there may be received from the delegates a retrieve manifest that identifies a manifest that describes existing content that is required by the delegatee to complete their delegated task. Content may then sent to the delegatee in response to the retrieve manifest.

To control work flow, the delegator may maintain a list of delegated items. Most usefully, the list may include a list of file folders or of content that has been delegated. The list may also specify a filesystem path that points to a root location of the content that has been delegated.

In order than a delegator can maintain control over the work, the manifest may specify whether the delegates can act as a delegator in respect of part or all of the delegated content.

Embodiments of this invention may operate on a client-server computer system. Each of the delegatees and the delegator are clients, and a server handles transfer of files and manifests between the clients. In such embodiments, the client and the server or servers may communicate over a network link.

In embodiments in which the system is implemented using a client and a server application, a user typically produces content on a computer that runs the client application. The client then co-operates with a server application to ensure that the content on the server computer is identical to the content on the client computer. The process has many applications but one of the most notable is the process of copying content from a content developer's computer to a web server.

Each manifest is advantageously encoded in extensible mark-up language.

A method embodying the invention may further include a step of making content received from a delegatee available on an externally accessible publication server. For example, the publication server may a web server, most typically accessible over the Internet or an intranet.

When a user produces a new content set the client system may identify differences between the new content and the content identified as having been delegated by the current manifest. It uses this set of differences to generate a list of tasks that have to be completed so that the content will be mirrored on the remote computer and generate a new manifest. The local computer then sends the new manifest to the remote computer and both computers co-operate to execute the tasks so that the content is identical on both.

From a second aspect, the invention provides a client/server computer system operative to perform a method of the first aspect of the invention. Such a system typically includes a server that is operative to distribute exchange manifests and files with clients in performance of a method according to the first aspect of the invention.

From a third aspect, the invention provides a client/server computer system for managing content for distribution comprising: a server, one or more delegator clients, and one or more delegates clients, the or each delegator client being operative to identify to the server content to be worked upon and a delegatee client to whom the work should be delegated, the server operative: to send to the delegatee client a manifest describing the delegated work, the manifest defining the extent of work to be done, to receive content from the delegatee client together with a returned manifest, and to accept the returned content only upon having verified each manifest and the associated content being digitally identified by the delegates

The server typically has storage for storing cryptographic information (such as a public cryptographic key) relating to each client. This can enable the server to perform secure communication with the clients. The server is typically operative to accept content from a client only in the event that the content is accompanied by a recognised cryptographic identifier. For example, the server may verify that the content is accompanied by a digital signature or by a message digest that can be authenticated by stored cryptographic information relating to the client.

A server in this aspect of the invention may identify content to a client by sending a manifest to the client. Most typically, a client returns content to the server accompanied by a manifest, but that content is, in preferred embodiments, accepted by the server only if the manifest includes authenticated cryptographic information.

A system embodying this aspect of the invention typically includes networking components for conveyance of data between the server and the clients.

Most typically, a server in a system embodying the invention includes a content store for storage of a hierarchical set of content. In such embodiments, the server is typically operative to delegate a part of the hierarchical content set.

In a system according to this aspect of the invention, the server may further include a publication server (for example, a web server) for distribution of content in response to remote requests.

This invention also provides a client system and a server system suitable for use in embodiments of this aspect of the invention.

The invention also provides computer program products for operating a client, a server, or a client/server system in accordance with a method according to the first aspect of the invention.

From a further aspect, the invention provides a server for maintaining a content set for serving to a remote client wherein each file in the content set is associated with a digital signature, in which the system is operational to verify that files in the content set correspond to the files defined (for example, by a cryptographic hash or message digest) in the digitally signed list or manifest, and deny access to any file for which the signature does not correspond.

This provides a web server that is resistant to malicious substitution of non-authorised content that could prove to be an embarrassment for the owner of the server.

This invention can be described as providing a process for automatically and reliably mirroring a set of files, referred to as content, on two computers. It is based on a data structure, called a manifest, which lists certain properties of the content to be mirrored with information about the individual that is authorised to produce the content.

Preferred embodiments of the invention make use of public key cryptography to verify the authenticity of manifests it receives. Public key cryptography is a system where individuals have two mathematically related keys that they use to encrypt data. One key, sometimes called a private key, is kept secret the other, called the public key, is distributed freely. If a piece of data is encrypted using one of the keys it can only be decrypted using the other.

If a user encrypts a piece of data with their private key, and stores the unencrypted and the encrypted data together, then anyone with that user's public key can prove that the user originated the data by decrypting the data using the user's public key and comparing the decrypted data with the clear text data. This process is involved in digitally signing the data.

Digital signing can be made more efficient by first generating a message digest. A message digest is a binary number (for example, of 128 bits) that can be considered to be unique for each data stream. The algorithm for creating a message digest is chosen such that a message digest can easily be computed from a data stream, but it is practically not possible to generate the data stream from the digest. Also, it is not computationally feasible to generate a data stream with a specified message digest.

In order to generate a digital signature, the user first generates the message digest for the data; then they encrypt the message digest with their private key. The user saves the unencrypted text with the encrypted digest (which is sometimes referred to as the digital signature). To verify the signature a third party first generates the message digest for the data. They then decrypt the signature using the signing user's public key. The computed digest and the decrypted digest can then be compared: if they match then the third party can be certain that the data originated from the user identified by the public key and the data was not altered after it was signed by the owner of the public key.

### BRIEF DESCRIPTION OF THE DRAWINGS

For a better understanding of the invention, reference is made to the drawings which are incorporated herein by reference, and in which:

FIG. 1 is a diagram of a client/server system embodying the invention;

FIG. 2 is a hierarchy of manifests representing levels of delegation in a system embodying the invention;

FIG. 3 illustrates an empty manifest used in embodiments of the invention by a client to communicate their identity to a server;

FIG. 4 illustrates a parent manifest used in embodiments of the invention to describe delegation of content to a client;

FIG. 5 illustrates a parent and child manifest; and

FIG. 6 is a flow diagram illustrating the process of delegating content in a system embodying the invention.

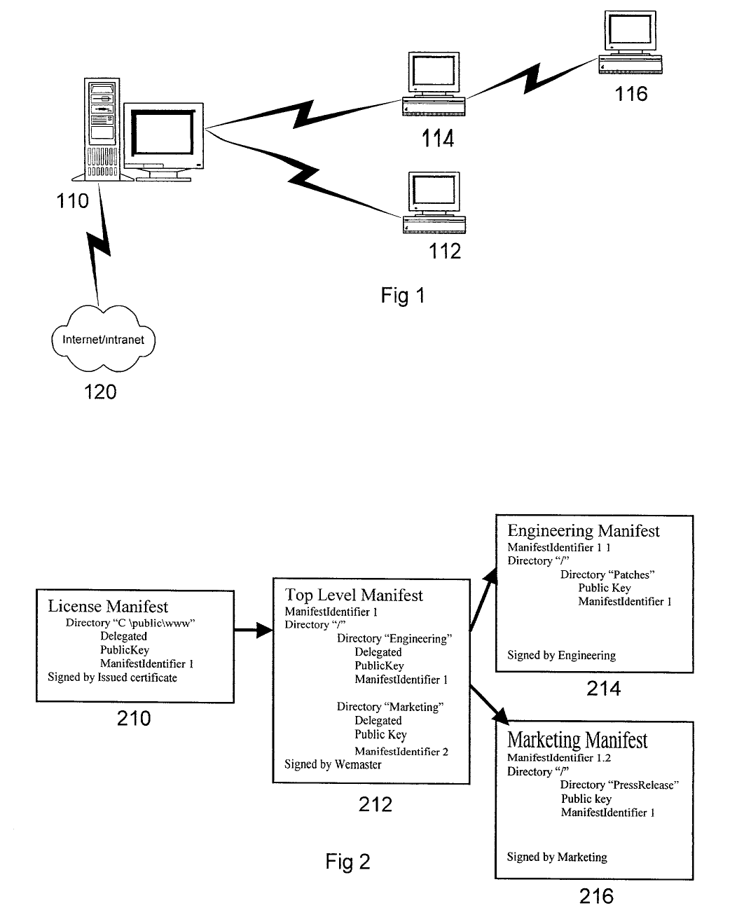

### DETAILED DESCRIPTION OF THE INVENTION

An embodiment of the invention will now be described in detail, by way of example, and with reference to the accompanying drawings.

This embodiment of the invention operates as a system for maintaining and serving web pages to a network. The system includes a server 110. The server 110 stores a hierarchy of content in a content repository for serving externally by way of a publication server. In this example, the content includes web pages that can be accessed using hypertext transfer protocol over a TCP/IP network 120 that might include the Internet or an intranet. To achieve this, the server includes (or is connected to) a web server than can be of conventional configuration.

The content stored by the server 110 is under the ultimate control of a webmaster which interacts with the server through a client system 130. However, the webmaster (who acts as a delegator) delegates responsibility for production and amendment of parts of the content hierarchy to one or more delegatees, each of which operates a client system 112, 114. The webmaster publishes the top level manifest (discussed below), and therefore has control over the entire content hierarchy. The server 110 therefore includes a content management system that permits a delegates controlled access to the content repository whereby the delegatee can store new or updated content in the delegated part of the hierarchy within the content repository. The content management system must ensure that a delegate cannot gain access to unauthorised parts of the hierarchy, nor that any unauthorised person can submit content to the system.

The concept of delegation is of prime importance to the workflow management functionality of embodiments of this invention.

The content on a client or server computer is described in this system as a hierarchical set of content sets. Each content set is assigned by the webmaster to a delegated individual, the delegated individual being identified by a public encryption key that belongs to the delegatee. The person responsible for each of the content sets can, in turn, delegate a portion of their content set to another individual, if they are authorised to do so by the owner of the content. When this delegation happens the delegator can impose certain restrictions on the delegation. For example they can prevent the delegate from delegating any of their content set, they can prevent the delegate from creating directories within their area of delegation in the hierarchy, and they can prevent the delegate from putting any executable files in their content set. When an individual submits content at each level, the content owner at the level above can be notified, for example using e-mail, that the content has been delivered.

Responsibility for content can be delegated as branches within the hierarchy. The hierarchical structure of the content sets therefore defines implicitly the workflow for content development.

In this system, a manifest is a data structure that describes a content set on a computer. It is stored in a computer's file system as an XML file.

The set of manifests on a computer defines a hierarchical structure which mirrors the hierarchical structure of the file system. The manifest at each level of the content is referenced by the manifest at the level above, the manifest at the top of the hierarchy is a special instance called a licence.

Each manifest must be signed by a private key using, the process described in the previous section, before the manifest will be accepted by the server. The corresponding public key is stored in the manifest above it in the hierarchy, called the parent manifest. The system verifies each manifest that it receives using the public key in the parent manifest. The licence (the manifest at the top of the hierarchy) is signed by the system administrator or webmaster.

When the system is installed, the system administrator generates a public and private key. The public key, along with some customer identification information, is then sent to the system vendor, who verifies that the requester is valid and that they have purchased a licence. If the request is valid the vendor will sign the user's public key with the vendor's private key, and return the signed key to the licensed user. This signed public key is referred to as a certificate, and is implemented using the X.509 certificate structure defined in RFC2459. This certificate is called the issued certificate, because it has been issued by the system vendor to the webmaster. The webmaster will then sign a licence manifest with their public key and the system will verify that the licence has been signed by a private key associated with a certificate that has been signed by the system vendor.

The server is configured such that it will not operate unless there is a valid licence, as described above, on the server. Since each manifest holds the public keys of owners of all subordinate manifests in the immediately subordinate level of delegation in the content hierarchy, and is signed with the private key of its own owner, there is a chain of trust from each signed manifest, through successive parents to the signed licence.

When the server system receives a new manifest from a client it identifies the manifest through its manifest ID. Then it uses the public key in the parent manifest to verify the signature.

The process of allocating a section of content to an individual and storing their public key in a manifest is called ‘delegation’.

In the example in FIG. 2, the licence 210 holds the public key of the webmaster, who maintains the top level manifest 212. The webmaster's manifest holds public keys for (in this example) the marketing web content producer and the engineering web content producer. The associated manifests 214, 216 hold public keys for further subordinate manifests.

Each manifest describes a directory tree. The contents of the directory tree are defined in the manifest itself while the position of the tree within a hierarchical filesystem is defined in the manifest directly above it (its parent manifest). In the example described in FIG. 2 the licence 210 defines the root of the tree to be in C:\public\www. This declares the top-level manifest 212 defines the content of this directory. The top-level manifest 212 declares that there are two directories, called “Engineering” and “Marketing”, and declares the manifest identifiers that will define the content for each directory. The manifests 214, 216 for each of these directories then define further delegated sub directories and the manifests that will define those.

The examples in Listings 1 to 4 show the XML code describing the licence and the three subordinate manifests. Listing 5 is the Document Type Definition (DTD) for the manifest with some superfluous information removed so that it can be more easily understood. Table 1 below shows the directory structure defined by the manifest tree described in Listings 1 to 4.

TABLE 1

\

Pu

blic\

ww\

index html
Engineerin

g\

Index html
Patches\

Marketing\

Index.html
PressReleas

e\

The directory structure in Table 1 appears only on the web site, and is assembled, by the server from content supplied by the authorised individuals. Note that each manifest names its top level directory as “/”, this is because the manifest defines only the contents of the directory (and, optionally, its subdirectories), the parent manifest defines the location of the directory within the hierarchy.

The system supports three types of manifest,

Licence manifest

The system requires a valid licence manifest to operate. If a valid licence manifest is not present the system will not load any further manifests. The licence manifest must be signed by a private key corresponding to a digital certificate that has been signed by the supplier of the system. The system is configured with the supplier's public key and uses this to verify the licence. This allows the supplier to control distribution and use of the system.

Directory manifest

This is the standard manifest that holds a description of the content set that of which a user has control.

Retrieve manifest

This is a pro-forma manifest that is sent by a client to the server which instructs the server to send all manifests belonging to the owner of the retrieve manifests back to the requesting client. The retrieve manifest holds a user's identity and the keyword ‘retrieve’.

These manifests will now be described in further detail.

The licence manifest contains the following information:

FullName: The full name of the individual who created the licence. This is generally the Webmaster, who installed the first client and generated the certificate request which was sent to the vendor for validation.

Organisation: The name of the organisation that owns the licence.

Email: The e-mail address of the individual who generated the licence.

Date: An optional field indicating an expiry date for the licence.

Limit: An optional field that indicates the maximum number of clients that may use the system.

LicenceNumber: A unique identifier for the licence.

PublicKey: The public key associated with the private key that the Webmaster will use to sign the top level manifest.

Directory: A description of the top-level directory that is controlled by the server 110. This tag is more completely described below. In the case of a licence, the directory must contain the “delegated” tag and the identity of the webmaster who controls the system.

The directory manifest is a manifest that contains the following information, describing the content set and the next level of delegation.

Revision: As each manifest is published the revision number is incremented so that the system can identify the newer manifest each time it receives a manifest.

Date: Specifies the date on which the manifest is to be published on the web site. If this field is absent, the server will publish the content on the web site as soon as it is received. Otherwise it will accept the content on the server, but keep it in a temporary area until the publication date, and then replace the current live content set (if any) with the new content set.

Title: This is a user-defined name for the manifest so that they can identify different manifests on their system.

Identity: The name and public key of the manifest owner.

Description: A user supplied description of the manifest.

Warning: A user supplied message that is displayed each time the user views the manifest.

Update: A revision log message which holds the revision number of the update, the date, an e-mail address of the updater and an update comment given by the updater.

GoldLocation: The directory on the content developers local machine where the content set is stored.

Server: The server, identified by a fully qualified domain name or an IP address, of the server to which to client will send the content set.

Peer: A list of zero or more server computers to which the prime server will copy the content set when it has been accepted.

Directory: The start of the tree describing the content set in this manifest. The elements of this tree are described in more detail in the next section, entitled ‘Directory description’.

Signature: This is a digital signature block generated using as message digest of the rest of the manifest and the private key of the individual to whom the manifest has been delegated.

Directory description: This part of the manifest describes the content set in detail, listing all the files and all delegations made by the owner of the current manifest. It contains the following keywords.

Name: the name of the directory

Exclude: a keyword that indicates to the server that it should completely ignore this directory. This may be useful for instances where the contents of a directory could be changed by other applications on the server.

Monitor: a keyword to indicate how the server should monitor this directory and files and directories within this directory. There are two parameters to this keyword:

Period indicates how often the directory should be monitored

Action indicates the action that the server should take when discrepancies are found within the directory.

Attributes: Indicates the operating system attributes that should be on the directory and on files and directories within the directory. Since this is operating system specific there are a set of attributes defined which could be mapped to the attributes available on most operating systems. The attributes defined are:

Owner, a string defining the owner of the file.

Group, a string defining the group owner of the file.

Omode, a string indicating the rights the owner of the file or directory has

Gmode, a string indicating the rights the group owner of a file or directory has

Wmode, a string indicating the rights other users have over the file or directory.

Date the date on which the file or directory was last modified.

Delegate: Indicates that this directory has been delegated to another individual. This data element will include the manifest identifier that will be used to define the delegated content and the public key of the individual that is entitled to publish that manifest.

Directory: The directory data element can contain nested directory elements that describe nested directories.

File: Description of files in the current directory. This data element contains such information as the file name, the file digest, the monitor period and the monitor action.

The Retrieve manifest contains the following content:

Retrieve: An alternative to the directory keyword that indicates to the server that it should return all manifests that have been assigned to the individual defined by the accompanying identity.

Identity: The identity of the person requesting the manifest. This includes the public key and their full name.

Signature: A signature block generated using a digest of the rest of the manifest and the private key of the individual requesting the manifest. The system server will confirm that the signer of the retrieve manifest is entitled to get the manifest requested by using the public key stored in the parent manifest.

Operation of the system will now be described.

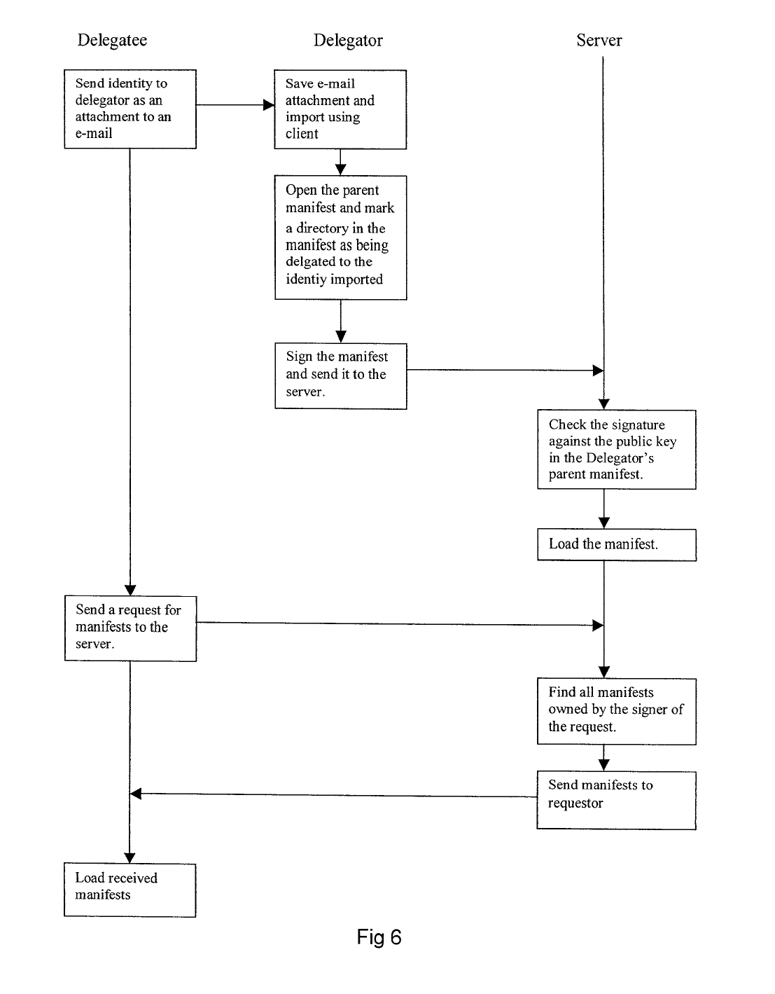

The process of delegating a content set is illustrated in FIG. 6.

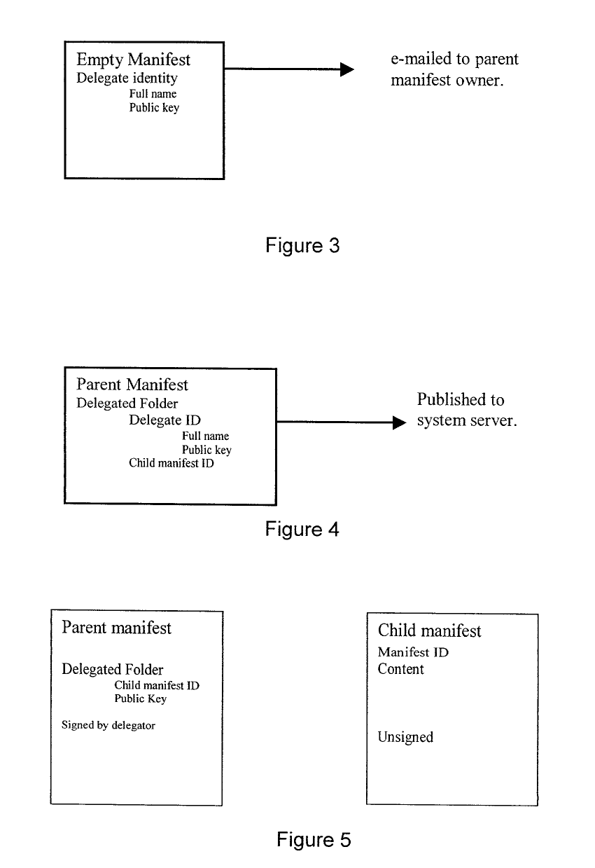

The individual to whom content will be delegated uses the client system to send their public key to the current owner of the content (that is, the delegator: the person who is delegating responsibility for content). The public key is sent in the form of a blank manifest as shown in FIG. 3, holding only the owner's identity (including the owner's full name and their public key). In this embodiment, the blank manifest is sent to the delegator as an attachment to an e-mail message.

The content owner saves the e-mail attachment in a file and imports the identity into their client system. Now the client system contains the public key of the individual to whom a directory will be delegated.

The delegator marks a directory or directory as delegated in their manifest. It is assigned to the delegate using the identity the delegate previously imported from the empty manifest, as described above. The client system selects a manifest identifier to identify a child manifest to define the content that is about to be delegated. This identifier, along with the delegated public key, is stored in the parent manifest, as shown in FIG. 4. The parent manifest is then published to the system server.

When the server receives a new parent manifest it will read it, detect that a directory has been newly delegated, and generate a child manifest describing the delegated content, as shown in FIG. 5. This may be empty if there is currently no content, or it may describe existing content. This manifest is not signed at this time. It will not be used by the system server until the delegatee has signed it.

The delegate must now retrieve the newly generated manifest so that they can manage their content. To do this, the delegate uses their client to send a retrieve manifest to the server. As described above the retrieve manifest contains only the owners identity and the keyword ‘retrieve’

When the server receives the ‘retrieve’ manifest it examines the identity of the owner of the retrieve manifest. It also checks that the manifest has been signed by that delegate's private key. Then it will generate jobs to send all manifests that belong to that identity back to the client that sent the parent manifest.

When the client receives the new manifest it loads it. If existing content listed in the manifest is already on the client then the user can start work immediately. However, if the client does not have the content then the user must use the client system to retrieve the content from the server.

The process of transferring content from a content development delegatee to the server will now be described.

The delegatee generates content on a local machine (for example, a PC or a file server) 112, 114, 116 that operates a client component of the system. The local machine need not necessarily have a permanent connection to the Internet and that need not necessarily run web server software. The client software runs on this machine and manages the process of transferring that content to the server 110 for serving on the Internet.

The delegatee configures the system client so that it knows

1. Where to find the web content that must be transferred identified in the manifest by the tag “GoldLocation”; and

2. Where to find the web server that will provide the content to the Internet identified in the manifest by the tag “server”.

The system client software creates a manifest describing all files that make up all of its content to be transferred to the server, along with a cryptographically secure signature for each file. The manifest can also specify delegation of control of a portion of the content to another user.

The system client pushes the manifest and associated content to the system server, which verifies the content against the signatures and saves the content in the content repository so that it can be made available by the web server in response to requests received. The client only pushes files that are new or that have changed, as compared with the content on the server 110. It will also send a request to delete files that should be removed from the server.

Files are exchanged between the two sites (for example, using the system described in patent application No. <to be inserted> or another file transfer process). Preferably, the transfer process is one that allows the recovery of partial file transfers, allows acknowledgement of complete and accurate transfer of the data, as well as being more efficient than text based HTTP for transferring blocks of data.

Periodically, the system server compares all content against the appropriate cryptographic signature. If it finds that any content does not match its signature then it assumes that that content has been altered or damaged in some way and it removes that content from the content repository so that it is no longer available as part of the web site. The server can then recover the content from a backup repository, or if the backup area has also been corrupted, it can make a request to the client to replace that content.

In cases where the web content is mirrored across several web servers, these web servers periodically contact each other to check that they have the most up-to-date content available. If a site discovers that one of the mirror sites has newer content than it has itself then it will request the newer content from the mirror site. The system servers identify peers using a tag in the top-level manifest.

Listing 1. The licence XML file

<?xml version=“1.0”?>
<!DOCTYPE Manifest SYSTEM “http.//www.mpt.ie/dtd/manifest1.dtd”>
<Manifest version=“1 0”>

<Licence>

<!--

The identity of the licence owner, this is used
Primarily for an e-mail address to send information
When the server starts and stops.

-->
<Identity>

<FullName>Jim Webmaster</FullName>
<Email>jim@mpt ie</Email>
<Authentication method=“publickey”>

<PublicKey>

87 c4 b0 d6

</PublicKey>

</Authentication>

</Identity>

<!--

This directory tag defines the location on the web site to which the server must publish content. The person specified in the identity is the person entitled to put content on the site. This need not be the same as the licence owner, though in this case it is

-->
<Directory name=“C /public/www”>

<Delegate>

<Identifier>1</Identifier>
<Identity>

<FullName>Jim Webmaster</FullName>
<Email>jim@mpt ie</Email>
<Authentication method=“publickey”>

<PublicKey>

87 c4 b0 d6

</PublicKey>

</Authentication>
</Identity>

</Delegate>
<Organization>Menlo Park </Organization>
<LicenceNumber>999</LicenceNumber>

<Certificate>

41 31 32 30 30 06 03 55 04 03 13 29 4d 65 6e 6c 6f 20 50 61 72 6b 20 54

</Certificate>

</Licence>
<Signature>

00 c3 fe f6 b7 91 29 a2 db 24 8a a1 8c

</Signature>

</Manifest>

Listing 2. The top-level manifest

```
<?xml version=“1 0”?>
<!DOCTYPE Manifest SYSTEM “http //www mpt ie/dtd/manifest1 dtd”>
<Manifest version=“1 0”>
  <Identifier>1</Identifier>
  <Date>973866316</Date>
  <Title>Top Level Manifest</Title>
  <Identity>
    <FullName>Jim Webmaster</FullName>
    <Email>jim@mpt ie</Email>
    <Authentication method=“publickey”>
      <PublicKey>87 c4 b0 d6</PublicKey>
    </Authentication>
  </Identity>
  <Description>
    This is the root manifest that defines the web site
  </Description>
  <GoldLocation>E:\gold</GoldLocation>
  <Client>jimspc</Client>
  <Server>webserver.mpt.ie</Server>
  <Directory name=“/”>
    <File name=“index html”>
      <Comment>Text Document</Comment>
      <Digest>6b 58 7e f3 40 8f 4d 74 de df 1f 25 27 94 75 88</Digest>
      <Location>974290298</Location>
    </File>
    <Directory name=“Engineering”>
      <Comment>Delegated to The Engineer</Comment>
      <Delegate>
        <Identity>
          <FullName>Ellen Engineer</FullName>
          <Authentication method=“publickey”>
            <PublicKey>03 01 00 01</PublicKey>
          </Authentication>
        </Identity>
        <SubIdentifier>1</SubIdentifier>
      </Delegate>
    </Directory>
    <Directory name=“Marketing”>
      <Comment>Delegated to Marketing Supervisor</Comment>
      <Delegate>
        <Identity>
          <FullName>Mary Marketer</FullName>
          <Authentication method=“publickey”>
            <PublicKey>a9 2f 7e 75</PublicKey>
          </Authentication>
        </Identity>
        <SubIdentifier>2</SubIdentifier>
      </Delegate>
    </Directory>
  </Directory>
  <Signature>
44 53 d4 65 33 91 34 a2 db 24 8a a1
  </Signature>
</Manifest>
```

Listing 3 Engineering Manifest

```
<?xml version=“1.0”?>
<!DOCTYPE Manifest SYSTEM “http //www mpt ie/dtd/manifest1.dtd”>
<Manifest version=“1 0”>
  <Identifier>1.1</Identifier>
  <Date>973866316</Date>
  <Title>Engineering Manifest</Title>
  <Identity>
    <FullName>Ellen Engineer</FullName>
    <Email>ellen@mpt ie</Email>
    <Authentication method=“publickey”>
      <PublicKey>03 01 00 01</PublicKey>
    </Authentication>
  </Identity>
  <Description>
    This is the root manifest that defines the web site
  </Description>
  <GoldLocation>E.\gold</GoldLocation>
  <Client>ellenspc</Client>
  <Server>webserver.mpt ie</Server>
  <Directory name=“/”>
    <File name=“index html”>
      <Comment>Engineering Home Page</Comment>
      <Digest>6b 58 7e f3 40 8f 4d 74 de df 1f 25 27 94 75 88</Digest>
      <Location>974290298</Location>
    </File>
    <Directory name=“Patches”>
      <Comment>Delegated to The Maintainer</Comment>
      <Delegate>
        <Identity>
          <FullName>Dan Coder</FullName>
          <Authentication method=“publickey”>
            <PublicKey>88 c1 e4 fb</PublicKey>
          </Authentication>
        </Identity>
        <SubIdentifier>1</SubIdentifier>
      </Delegate>
    </Directory>
  </Directory>
  <Signature>
65 33 91 34 a2 db 24 8a a1 8c a6 82
  </Signature>
</Manifest>
```

Listing 4 Marketing Manifest

```
<?xml version=“1.0”?>
<!DOCTYPE Manifest SYSTEM “http //www mpt ie/dtd/manifest1 dtd”>
<Manifest version=“1 0”>
  <Identifier>1.2</Identifier>
  <Date>973866316</Date>
  <Title>Marketing Manifest</Title>
  <Identity>
    <FullName>Mary Marketer</FullName>
    <Email>mary@mpt.ie</Email>
    <Authentication method=“publickey”>
      <PublicKey>a9 2f 7e 75</PublicKey>
    </Authentication>
  </Identity>
  <Description>
    This is the root manifest that defines the web site.
  </Description>
  <GoldLocation>E \gold</GoldLocation>
  <Client>maryspc</Client>
  <Server>webserver.mpt ie</Server>
  <Directory name=“/”>
    <File name=“index.html”>
      <Comment>Marketing Department Home Page</Comment>
      <Digest>6b 58 7e f3 40 8f 4d 74 de df 1f 25 27 94 75 88</Digest>
      <Location>974290298</Location>
    </File>
    <Directory name=“PressRelease”>
      <Comment>Delegated to The journalist</Comment>
      <Delegate>
        <Identity>
          <FullName>Eva Journalist</FullName>
          <Authentication method=“publickey”>
            <PublicKey>c1 e4 fb 39</PublicKey>
          </Authentication>
        </Identity>
        <SubIdentifier>1</SubIdentifier>
      </Delegate>
    </Directory>
  </Directory>
  <Signature>
8a a1 8c a6 82 27 23 3f 2f fc 15 e6 f8 34
  </Signature>
</Manifest>
```

Listing 5. The manifest DTD

<!--
The enclosing element is the Manifest element.
A licence is a special case of a manifest file that must
be signed using MPT's private key.
If there is a date at this level of the manifest file
it indicates the date on which the file should be published.
-->
<!ELEMENT Manifest ((Licence | (Revision, Date?, Title, Identity,

Description, Warning?, Update*,
GoldLocation, Client, Server*,
Host*, (Directory* | Retrieve)),
Signature?)>

<!ATTLIST Manifest version CDATA #REQUIRED>
<!--
The licence element has a contact information as well as a serial
number that identifies the licence and the public key of the
servers cert The software will be enabled once the licence file
has been signed by MPT, the server will only accept root
manifest files that it has signed The Date element indicates
an expiry date for the licence The Identifier element starts
the “trust chain” by specifying the name of the first manifest
in the chain This will be signed by the private key of the
server.
-->
<!ELEMENT Licence (FullName, Organization, Email, Date?, Limit?

LicenceNumber, PublicKey, Identifier,
Certificate, Directory)>

| <!-- | |
|---|---|
| An Identity is a Full Name, which is some character data | |
| folowed by an authentication method and the information | |
| necessary to authenticate the user. This is either a username | |
| and password or a public key. If the authentication method is a | |
| cert then we add enough information to identify the certificate | |
| to support the case where the customer has PKI | |
| --> | |
| <!ELEMENT Identity (FullName, Authentication)> | |
| <!ELEMENT FullName (#PCDATA)> | |
| <!ELEMENT Authentication (CommonName \| DistinguishedName \| PublicKey)> | |
| <!ATTLIST Authentication method (cname \| dname \| publickey) #REQUIRED> | |
| <!ELEMENT CommonName (#PCDATA)> | |
| <!ELEMENT DistinguishedName (#PCDATA)> | |
| <!ELEMENT PublicKey (#PCDATA)> | |
| <!ELEMENT Date EMPTY> | |
| <!ATTLIST Dateyear | CDATA #REQUIRED |

| | |
|---|---|
| month | CDATA #REQUIRED |
| day | CDATA #REQUIRED |
| hour | CDATA #REQUIRED |
| minute | CDATA #REQUIRED> |

<!ELEMENT Email (#PCDATA)>
<!ELEMENT Log (#PCDATA)>
<!--
The location of the master (or Gold) image is specified in
the manifest for use by the client The path specified
here is specific to the client type
-->
<!ELEMENT GoldLocation (#PCDATA)>
<!--
The list of peers that mirror the content described by this
manifest The peers could be identified either by FQDN, IP
address, public key, or a combination of these
-->
<!ELEMENT Client (#PCDATA)>
<!ELEMENT Server (#PCDATA)>
<!--
This element is used to specify a number of directories
that will be reproduced on only one of the mirroring
servers The server is identified by it's name which can
be either an FQDN or an IP address We may want to
consider identify the server by it's public key since that
would be much more secure than either its name or address.
-->
<!ELEMENT Host (Directory+)>
<!ATTLIST Host name CDATA #REQUIRED>
<!--
This element describes the directory structure. The directory
can either be delegated or it can have monitoring information
-->
<!ELEMENT Directory (State?, (Exclude | (Monitor?, Attributes?,

(Delegate | (Directory*, File*)))))>

<!ATTLIST Directory name CDATA #REQUIRED>
<!--
This keyword is used to automatically retrieve a manifest from
a remote server - useful for a new delegation.
-->
<!ELEMENT Retrieve (#PCDATA)>
<!--
The Exclude tag is used to exclude a file or directory
from being included during a file/directory populate
-->
<!ELEMENT Exclude EMPTY>
<!--

If the Lock tag appears in the delegate tag then the
delegation is being revoked The process for this is
that the server will refuse any further manifest
revisions
The server will push the content for the revoked
manifest back to the client of the revoking (the
current) manifest.
When the content has been completely pushed back
the UI will support merging the current and the
revoked manifest

| | --> |
|---|---|
| | <!ELEMENT Delegate (Identity+, Identifier, Lock?)> |
| | <!ELEMENT Identifier (#PCDATA)> |
| | <!ELEMENT Lock EMPTY> |
| | <!ELEMENT Monitor (Period, Action)> |
| | <!ELEMENT File (State?, (Exclude \| |
| (Digest, Monitor?, Attributes?)))> | |
| | <!ATTLIST File name CDATA #REQUIRED> |
| | <!ELEMENT Digest (#PCDATA)> |
| | <!-- |
| | The signature generated by the application that wrote this |
| | manifest |
| | --> |
| | <!ELEMENT Signature (#PCDATA)> |

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is

1. A method of managing content for distribution comprising: a delegator identifying content to be worked upon and delegating the work to a delegatee; sending to the delegatee a manifest describing the delegated work, the manifest defining the extent of work to be done; receiving content from the delegatee together with a returned manifest, each manifest and the associated content being digitally identified by the delegatee; the returned content being accepted only upon verification of the digital identification.

2. A method according to claim 1 in which, prior to assigning content to a delegate, a public cryptographic key is obtained from the delegatee.

3. A method according to claim 2 in which the returned manifest is verified by a digital signature of the delegatee.

4. A method according to claim 3 in which the digital signature is verified by decryption using the delegatee's public key.

5. A method according to claim 3 in which the digital signature is signed in accordance with the X509 certificate structure.

6. A method according to claim 1 in which each file that accompanies a manifest is digitally identified and is accepted only upon verification of the digital identification.

7. A method according to claim 1 in which there is received from the delegatee a request for a manifest describing existing content that is required by the delegatee to complete their delegated task.

8. A method according to claim 7 in which the manifest is sent to the delegatee in response to the request.

9. A method according to claim 1 in which the delegator maintains a list of delegated items.

10. A method according to claim 9 in which for each delegated item, the list includes a list of content that has been delegated.

11. A method according to claim 9 in which for each delegated item, the list specifies a file system path that points to a root location of the content that has been delegated.

12. A method according to claim 1 in which the manifest specifies whether the delegatee can act as a delegator in respect of part or all of the delegated content.

13. A method according to claim 1 operating on a client-server computer system.

14. A method according to claim 13 in which the delegator operates as a server to one or more client delegatees.

15. A method according to claim 13 in which each of the delegator and the or each delegates are clients.

16. A method according to claim 15 in which a server handles transfer of files and manifests between the clients.

17. A method according to claim 15 in which the server or servers communicate over a network link.

18. A method according to claim 15 in which a user produces content on a computer that runs a client application.

19. A method according to claim 18 in which the client application co-operates with a server application to ensure that the content on the server computer is identical to the content on the client computer.

20. A method according to claim 1 in which each manifest is encoded in extensible mark-up language.

21. A method according to claim 1 further including a step of making content received from a delegatee available on an externally accessible publication server.

22. A method according to claim 21 in which the publication server is a web server.

23. A method according to claim 22 in which the web server is accessible over the Internet or an intranet.

24. A method according to claim 1 in which, in the event that a user produces a new content set the differences between the new content and the current are determined, and from that differences, a list of tasks is generated that have to be completed so that the content will be mirrored on the remote computer and generates a manifest accordingly.

25. A method according to claim 24 in which the tasks in the list of tasks are executed.

26. A client/server computer system operating to perform a method according to claim 1.

27. A client/server computer system for managing content for distribution comprising: a server, one or more delegator clients, and one or more delegatee clients, the or each delegator client being operative to identify to the server content to be worked upon and a delegatee client to whom the work should be delegated; the server operative: to send to the delegatee client a manifest describing the delegated work, the manifest defining the extent of work to be done, to receive content from the delegates client together with a returned manifest, and to accept the returned content only upon having verified each manifest and the associated content being digitally identified by the delegatee.

28. A system according to claim 27 in which the server has storage for storing cryptographic information relating to each client.

29. A system according to claim 27 in which the server is operative to accept content from a client only in the event that the content is accompanied by a recognised cryptographic identifier.

30. A system according to claim 29 in which the server is operative to verify that the content is accompanied by a digital signature that can be authenticated by stored cryptographic information relating to the client.

31. A system according to claim 28 in which the server identifies content to a client by sending a manifest to the client.

32. A system according to claim 31 in which content is returned to the server by a client accompanied by a manifest authenticated by cryptographic information.

33. A system according to claim 27 which further includes networking components for conveyance of data between the server and the clients.

34. A system according to claim 27 in which the server includes a content store for storage of a hierarchical set of content.

35. A system according to claim 34 in which the content to be delegated comprises part of the hierarchical content set.

36. A system according to claim 27 which further includes a publication server for distribution of content in response to remote requests.

37. A system according to claim 36 in which the publication server is a web server.

38. A client system for use in a client/server computer system according to claim 27.

39. A server system for use in a client/server computer system according to claim 27.

40. A computer program product for operating a client or a server to perform a method according to claim 1.

41. A server for maintaining a content set for serving to a remote client wherein each file in the content set is associated with a digital signature, in which the system is operational to verify that files in the content set correspond to the digital signature, and deny access to any file for which the signature does not correspond.
